(19) United States
(12) Patent Application Publication
(10) Pub. No.: US 2012/0060152 A1
(43) Pub. Date: Mar. 8, 2012

(54) SYSTEM AND METHOD FOR FIRMWARE UPDATE OF METER, WATT HOUR METER WITH FUNCTION OF REMOTE FIRMWARE UPDATE

(75) Inventors: Jung Hwan OH, Seoul (KR); Jae Seong Park, Daejeon (KR)

(73) Assignee: LSIS CO., LTD.

(21) Appl. No.: 13/216,185

(22) Filed: Aug. 23, 2011

(30) Foreign Application Priority Data
Sep. 3, 2010 (KR) 10-2010-0086740

(51) Int. Cl. G06F 9/44

(52) U.S. Cl. 717/170; 717/173

(57) ABSTRACT

According to the present disclosure, an energy meter installed at each energy consumer receives in advance a new firmware from a remote server, and updates its own firmware at a future time. The energy meter may receive update time information designating a future time when downloading the firmware, or may execute the update in response to update execution instruction from the remote server once the firmware is downloaded. The firmware update may be executed for each module unit. Communication traffic can be dispersed because the download is given to each energy meter in advance before a time firmware or firmware module update is to be executed. A large load is prevented from being loaded to the remote server at once. It is easy to manage or control a plurality of energy meters because the update can be executed in a lump.

Pursuant to 35 U.S.C. §119 (a), this application claims the benefit of earlier filing date and right of priority to Korean Patent Application No. 10-2010-0086740, filed on Sep. 3, 2010, the contents of which are hereby incorporated by reference in their entirety.

### BACKGROUND OF THE DISCLOSURE

1. Field

Exemplary embodiments of the present disclosure may relate to a system and a method for firmware update of an energy meter installed at each energy consumer for communicating with a remote server through a communication network to update its firmware, and a watt hour meter with function of remote firmware update.

2. Background

Many attempts have been recently made to efficiently use limited natural resources. Concomitant with the attempts, methods have been waged to differentiate energy prices based on energy production and consumption circumstances, and a technology called smart grid or smart meter has been gaining attentions of various fields.

The smart grid is a next generation bi-directional technological framework to realize efficient power usage by constructing a new transmission network having a communication channel along with the transmission network and using this intelligent transmission network. The background idea of the smart grid is to realize efficient management of the amount of power use, swift handling of an incident when such an incident occurs, remote control of the amount of power use, distributed power generation using power generation facilities outside the control of a power company, or charging management of an electric vehicle.

Particularly, effective utilization of in-house power generating stations using renewable energy by ordinary households or operators other than power companies and charging management of various electric vehicles typically including electric cars have been attracting considerable attention. Incidentally, renewable energy is energy generated without using fossil fuel.

More recently, many utility companies and government agencies have been installing “smart meters” which are electronic meters which can record cumulative or total energy usage and transmit the data to a central location, avoiding the need to employ a fleet of meter readers to take meter readings. The smart meter also facilitates data collection in terms of speed, accuracy and total cost of collection. Moreover, the smart meter allows for more detailed monitoring of time of use, cost and other data. Most smart meters are configured to monitor usage and apply different rates or tariffs for energy usage based on a current rate period or time of use period.

Introduction of smart meter by utility companies and service providers is driven in part by the need to encourage reduced consumption during peak hours, and typically several tariffs are provided dependent on time of use (e.g., peak/off-peak) to provide a cost incentive for off peak use, or energy conservation during peak periods.

Meantime, the energy meters installed at each energy consumer for measuring energy consumption are operated by firmware.

The firmware is a computer program or a binary image file embedded in a device, stored in a storage unit such as flash ROM of the device itself. Currently, many devices are special-purpose computers, executing specific firmware for functionality thereof. Many types of electronic devices, including standalone and peripheral device, operate using some form of firmware, that is, program instruction. Although the firmware is usually embedded in electronic devices from the moment of shipping from factories, update of firmware is necessary for various purposes including performance enhancement and error correction.

That is, firmware updates are required to fix bugs in the firmware, addressing functionality issues, and/or improving the performance and reliability of a device after the device is shipped.

The energy meter is installed at every energy consumer, such that the number of energy meters is so numerous. For example, an approximately ten thousand of energy meters is installed in Korean homes. It therefore takes too many hours of time and cost for meter readers to visit each home for taking meter readings and firmware update.

Particularly, in smart grid initiatives, the energy meters perform much more functions, whereby update for improvement of energy meters may be more frequently realized.

In consideration of these trends, developments for efficiently performing firmware on a plurality of energy meters are urgently needed.

Conventionally, firmware updates must be manually performed using a software tool by users under OS (Operating System) environment. In this method, users must understand software tools, and have related update technical knowledge. For general users, however, conventional firmware updates are complicated and inconvenient.

### SUMMARY OF THE DISCLOSURE

The present disclosure seeks to overcome, or at least ameliorate, one or more of the disadvantages of these known firmware update system and method, or at least provide an alternative, and therefore, it is an object of the present disclosure to provide a system and a method for firmware update of an energy meter, in which an energy meter can update its firmware by itself at a future time by placing and receiving in advance a new firmware from a remote server to efficiently perform firmware update of multiple energy meters, and a watt hour meter with function of remote firmware update.

Technical subjects to be solved by the present disclosure are not restricted to the above-mentioned description, and any other technical problems not mentioned so far will be clearly appreciated from the following description by the skilled in the art.

In one general aspect of the present disclosure, there is provided a system for remote firmware update of an energy meter, the system comprising: a remote server generating and managing operation of firmware (program instruction) of an energy meter; a communication network connecting the remote server and the energy meter; and an energy meter receiving a new firmware module from the remote server through the communication network capable of update for each module and update time information which is a future time on which the new firmware module operates, and recording the new firmware module and the update time information in storage means, wherein the remote server transmits the new firmware module and the update time information to the energy meter prior to the update, and the energy meter checks integrity of the received new firmware module, and independently executes the update operation at the update time for each module recorded in the storage means.

Preferably, the remote server transmits the new firmware and update time information to the energy meter in advance before the update time, and the energy meter checks integrity of the new firmware, and operates as a new firmware before the upgrade time recorded in the storage means.

In another general aspect of the present disclosure, there is provided a system for remote firmware update of an energy meter, the system comprising: a remote server generating and managing operation of firmware (program instruction) of an energy meter; a communication network connecting the remote server and the energy meter; and an energy meter receiving a new firmware module from the remote server through the communication network capable of update for each module and update time information which is a future time on which the new firmware module operates, and recording the new firmware module and the update time information in storage means.

Preferably, the remote server transmits the new firmware module and update time information to the energy meter in advance before the update time, and the energy meter checks integrity of the new firmware module, and executes update operation independently at each module update time recorded in the storage means.

In still another general aspect of the present disclosure, there is provided a method for remote firmware update of an energy meter, the method comprising: transmitting a new firmware and update time information in advance, by a remote server generating firmware and managing operation of the firmware of an energy meter, to the energy meter; receiving, by the energy meter, the new firmware and the update time information from the remote server and storing the new firmware and the update time information in storage means; monitoring, by the energy meter, whether a current time has become an update time; and updating, by the energy meter, a current firmware to a new firmware recorded in the storage means, if the current time has become the update time as a result of the monitoring.

In still another general aspect of the present disclosure, there is provided a method for remote firmware update of an energy meter, the method comprising: transmitting, by a remote server generating and managing a firmware of the energy meter capable of update for each module, a new firmware module and update time information to the energy meter in advance; receiving, by the energy meter, the new firmware module and the update time information from the remote server and storing the new firmware module and the update time information in storage means; monitoring, by the energy meter, whether a current time has become an update time; and independently executing update of new firmware module, by the energy meter, if the current time has become the update time as a result of the monitoring.

In still another general aspect of the present disclosure, there is provided a method for remote firmware update of an energy meter, the method comprising: transmitting a new firmware in advance, by a remote server generating firmware and managing operation of the firmware of the energy meter, to the energy meter; receiving, by the energy meter, the new firmware from the remote server and storing the new firmware in storage means; transmitting, by the remote server, a firmware update execution instruction to the energy meter; and executing update, by the energy meter receiving the firmware update execution instruction, to new firmware recorded in the storage means.

In still another general aspect of the present disclosure, there is provided a method for remote firmware update of an energy meter, the method comprising: transmitting, by a remote server generating and managing a firmware of the energy meter capable of update for each module to the energy meter; receiving, by the energy meter, the new firmware module from the remote server and storing the new firmware module in storage means; transmitting, by the remote server, a firmware update execution instruction to the energy meter; and executing independent update of new firmware module recorded in the storage means, by the energy meter receiving the firmware update execution instruction.

Preferably, the energy meter measures any one of electricity, gas and water consumption.

Preferably, the energy meter stores currently operating firmware information in the storage means.

Preferably, the firmware information to be stored includes at least a firmware version and update time.

Preferably, the energy meter records a firmware update attempt and a history of a result of the firmware update attempt in the storage means.

Preferably, the energy meter records and manages a firmware update attempt and a history of a result of the firmware update attempt in the storage means.

Preferably, the energy meter operates by using pre-set operation environment (configuration) before the update even if the firmware update has been executed.

In still further another general aspect of the present disclosure, there is provided a watt hour meter with function of remote firmware update, the watt hour meter comprising: communication means receiving, from a remote server through a communication network, a new firmware of the watt hour meter and update time information which is a future time on which the new firmware operates; non-volatile storage means recording the received new firmware and update time information; time check means measuring a current time, wherein the watt hour meter checks integrity of the new firmware, and operates with the new firmware if the current time measured by the time check means becomes the update time recorded in the storage means.

In still further another general aspect of the present disclosure, there is provided a watt hour meter with function of remote firmware update, the watt hour meter comprising: communication means receiving, from a remote server through a communication network, a new firmware of the watt hour meter and update time information which is a future time on which the new firmware operates; non-volatile storage means recording the received new firmware and update time information; time check means measuring a current time, wherein the watt hour meter checks integrity of the new firmware, and operates with the new firmware if the current time measured by the time check means becomes the update time recorded in the storage means, or if firmware update execution instruction is received from the remote server through the communication means.

In still further another general aspect of the present disclosure, there is provided a watt hour meter with function of remote firmware update, the watt hour meter comprising: communication means receiving, from a remote server through a communication network, a new firmware module capable of update for each module and update time information which is a future time on which the new firmware operates; non-volatile storage means recording the received new firmware module and update time information; time check means measuring a current time, wherein the watt hour meter checks integrity of the new firmware, and operates with the new firmware if the current time measured by the time check means becomes the update time recorded in the storage means.

In still further another general aspect of the present disclosure, there is provided a watt hour meter with function of remote firmware update, the watt hour meter comprising: communication means receiving, from a remote server through a communication network, a new firmware module capable of update for each module and update time information which is a future time on which the new firmware operates; non-volatile storage means recording the received new firmware module and update time information; time check means measuring a current time, wherein the watt hour meter checks integrity of the new firmware, and independently executes update of the new firmware module if the current time measured by the time check means becomes the update time recorded in the storage means, or if firmware update execution instruction is received from the remote server through the communication means.

Preferably, the firmware includes at least one or more of a module in charge of application of the energy meter, a module in charge of communication and a module in charge of metrology.

Preferably, the current time measured by the time check means may be adjusted, where the adjustment of current time may be implemented by communication with other devices, or may be personally implemented by a user through a user interface disposed at the watt hour meter.

Preferably, the watt hour meter of each exemplary embodiment may store the currently operating firmware information in the storage means, where the information to be stored includes firmware version information and update time information.

Preferably, the watt hour meter of each exemplary embodiment may store update attempt, and a history of a result of update attempt in the storage means.

Preferably, the watt hour meter of each exemplary embodiment may operate using operation environment (configuration) pre-set before the update even if the firmware update has been executed without any change on the operation environment (configuration).

### BRIEF DESCRIPTION OF THE DRAWINGS

Accompanying drawings are included to provide a further understanding of arrangements and embodiments of the present disclosure and are incorporated in and constitute a part of this application. Now, non-limiting and non-exhaustive exemplary embodiments of the disclosure are described with reference to the following drawings, in which

FIG. 1 is a schematic conceptual view illustrating a remote firmware update system according to the present disclosure;

FIG. 2 is a firmware update of an energy meter through a remote firmware update system according to exemplary embodiments of the present disclosure;

FIG. 3 is firmware of module structure according to an exemplary embodiment of the present disclosure;

FIG. 4 is a block diagram illustrating function of a remote firmware update system according to exemplary embodiments of the present disclosure;

FIG. 5 is a conceptual view of firmware update;

FIGS. 6 to 9 are views illustrating a remote firmware update method according to the present disclosure;

FIG. 10 is a block diagram illustrating function of a watt hour meter according to the present disclosure; and

FIGS. 11, 12 and 13 are detailed processes in which a watt hour meter operates according to exemplary embodiments of the present disclosure.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the method particularly pointed out in the written description and claims hereof as well as the appended drawings.

### DETAILED DESCRIPTION

Hereinafter, exemplary embodiments of the present disclosure are described in detail with reference to the accompanying drawings. It will be appreciated that for simplicity and/or clarity of illustration, elements illustrated in the figure have not necessarily been drawn to scale. For example, the dimensions of some of the elements may be exaggerated relative to other elements for clarity. Further, if considered appropriate, reference numerals have been repeated among the figures to indicate corresponding and/or analogous elements.

Particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled”, and “connected” may mean that two or more elements do not contact each other but are indirectly joined together via another element or intermediate elements.

Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “comprise” and “include,” along with their derivatives, may be used and are intended as synonyms for each other. Furthermore, the terms “including”, “includes”, “having”, “has”, “with”, or variants thereof are used in the detailed description and/or the claims to denote non-exhaustive inclusion in a manner similar to the term “comprising”.

Words such as “thereafter,” “then,” “next,” etc. are not intended to limit the order of the processes; these words are simply used to guide the reader through the description of the methods. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

In describing the present disclosure, detailed descriptions of constructions or processes known in the art may be omitted to avoid obscuring appreciation of the invention by a person of ordinary skill in the art with unnecessary detail regarding such known constructions and functions.

Now, the system and method for firmware update of meter, watt hour meter with function of remote firmware update according to the present disclosure will be described in detail with reference to the accompanying drawings.

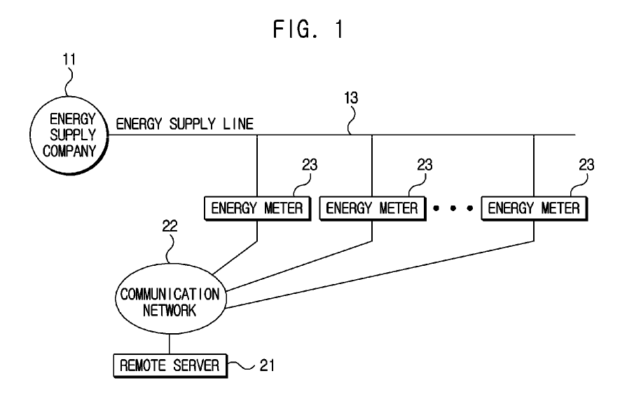

Referring to FIG. 1, an energy provider (11) supplies energy to each energy consumer through an energy supply line (13), where each energy consumer is installed with an energy meter (23) connected to the energy supply line (13) for measuring energy consumption of a relevant energy consumer.

The energy with reference to the present disclosure may refer to any one of electricity, gas and water, and the energy meter may refer to a watt hour meter, a gas meter or a water meter.

A system for remote firmware update of an energy meter according to the present disclosure includes a remote server (21) and an energy meter (23), where the remote server (21) and the energy meter (23) exchanges information related to the firmware update through a communication network (22).

The communication network (22) communicating with the remote server (21) and the energy meter (23) may include various communication networks. In a non-limiting example, the communication network (22) may include a power line communication network, an Internet network, a CDMA (Code Division Multiple Access) network, a PCS (Personal Communication Service) network, a PHS (Personal Handyphone System) network and a Wibro (Wireless Broadband Internet) network.

The remote server (21) generates and manages firmware which is a program instruction controlling operation of the energy meter (23), and transmits a new firmware to the energy meter (23) in advance. That is, the energy meter (23), in its position, receives the new firmware in advance before a time on which a relevant firmware is supposed to be updated.

Various configurations may be formed as to when to send the firmware by the remote server (21). In a non-limiting example, the energy meter (23) may be periodically connected to the remote server (21) to check if a recent version of firmware is present, and request download of the recent version of firmware from the remote server (21) if there is any new version of firmware that has not been downloaded. Then, the remote server (21) may transmit a relevant firmware to the energy meter (23) in response to the request.

Furthermore, the firmware download at the energy meter (23) may be implemented by notifying, by the remote server (21), the presence of new firmware to the energy meter (23).

The energy meter (23) may be variably configured according to types and required functions of energy, and basically measure energy consumption consumed by relevant consumers by being connected to the energy supply line (13).

The energy meter (23) is operated by firmware, where the firmware is generally stored in ROM (Read-Only Memory) of the energy meter (23). The firmware in the present disclosure is updated, such that the energy meter (23) maintains the firmware in the ROM capable of reading and writing.

Particularly, a new firmware is beforehand downloaded in the energy meter (23) prior to a time on which update of a relevant firmware is to be executed, and recorded in storage means, and when the time has come to implement the update of the firmware, the energy meter (23) updates the current firmware to a pre-downloaded firmware.

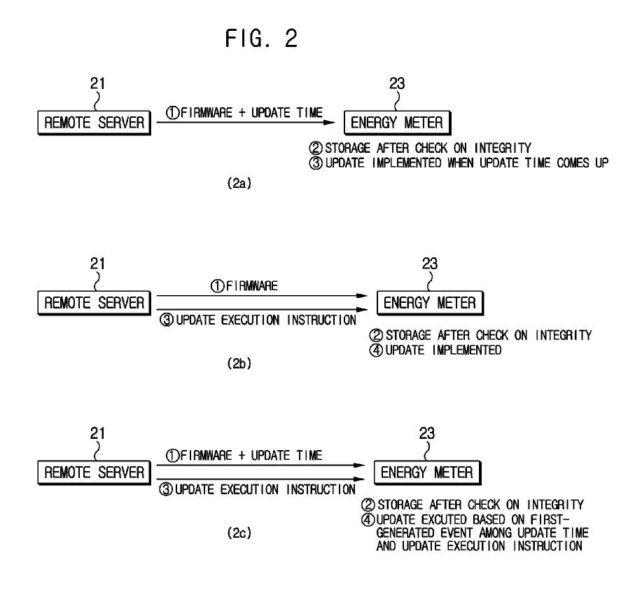

Referring to FIG. 2, each exemplary embodiment in which firmware update is executed between the remote server (21) and the energy meter (23) will be described.

Referring to FIG. 2a, the remote server (21) may transmit firmware and its update time information to the energy meter (21) in advance. The energy meter (23) stores the firmware received from the remote server (21) and the update time information of the received firmware in storage means. The energy meter (23) monitors whether the firmware update time has come up, and executes the firmware update using the firmware stored in the storage means when the firmware update time has come up.

Referring to FIG. 2b, the remote server (23) transmits the firmware to the energy meter (23) in advance, where the energy meter (23) stores the firmware received from the remote server (21) in the storage means.

Thereafter, the remote server (21) transmits an update execution instruction to the energy meter (21) when a time has come up for updating the firmware of the energy meter (23), where the energy meter (23) executes the update to the firmware stored in the storage means in response to the update execution instruction received from the remote server (21).

Referring to FIG. 2c, the remote server (21) transmits the firmware and the update time information to the energy meter (23) in advance, where the energy meter (23) stores the firmware and the update time information received from the remote server (21) in the storage means.

The energy meter (23) executes the update to the firmware stored in the storage means when a relevant time comes up while monitoring whether the firmware update time has come up. Furthermore, even before the firmware update time, the energy meter (23) executes the update to the firmware stored in the storage means if the update execution instruction is received from the remote server (21).

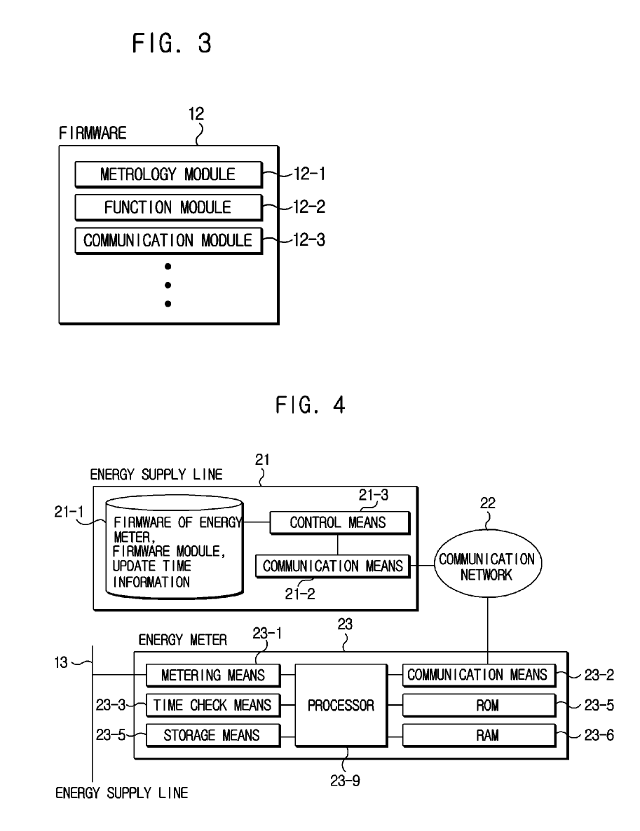

Meantime, an entire firmware may be integrally formed, and as shown in FIG. 3, the firmware may be formed in individual modules capable of executing the individual update.

The modules forming the firmware may be variably configured. In a non-limiting example, the modules may include a module in charge of application of the energy meter, a module in charge of communication and a module in charge of metrology.

In a case the firmware is formed with modules capable of executing individual update, the remote server (21) can generate or manage the firmware for each module, and the firmware update according to the present disclosure can be also executed for each firmware module.

At this time, the remote server (21) can transmit the firmware to the energy meter (23) for each module, and the update time information or the update execution instruction can be also transmitted to each firmware module.

Then, the energy meter (23) monitors whether the firmware module update beforehand received from the remote server (21) has come up, or the update execution instruction has been received from the remote server (21) for each firmware module, to independently execute the update operation of relevant firmware module.

Although the firmware update thus described may be executed for each firmware unit or module unit, it should be apparent that update of firmware unit and update of the module unit can be simultaneously executed. In a non-limiting example, the remote server (21) can transmit the whole entire firmware modules or part of firmware modules to the energy meter (23) in a lump.

The energy meter (23) may check the integrity of firmware received from the remote server (21) or firmware module, where the expression of integrity check is to check whether firmware or firmware module has been all received normally.

The integrity of an update is very important, because applying a faulty or even intentionally manipulated update could render the device useless.

The remote server (21) can also transmit bibliographic information such as types, number of firmware and size for integrity check, and the energy meter (23) can compare the bibliographic information with the received information to check the integrity of update.

As a result of the integrity check, if the firmware or firmware module has not been received normally, the energy meter (23) may communicate with the remote server (21) to receive a relevant firmware or firmware module again.

FIG. 4 is a block diagram illustrating function of a remote firmware update system according to exemplary embodiments of the present disclosure.

The remote server (21) is a computer system implementing a function of a server, and may include communication means communicating with each energy meter (21) through a communication network (22), storage means (21-1) and control means (21-3).

The storage means (21-1) is stored with various pieces of information for firmware update including firmware of energy meter (23) and update time information of the energy meter (23). In a case the firmware is formed with each module capable of individual update, each firmware module and update time information thereof may be stored in the storage means (21-1).

Communication means (21-2) is configured to communicate with the energy meter (23) through the communication network (22). For example, the communication means (21-2) may be a modem capable of being connected to wired or wireless Internet network.

The control means (21-3) may be formed using a CPU (Central Processing Unit) and transmit various pieces of information related to firmware update to the energy meter (23).

Referring to FIG. 2a, the control means (21-3) transmits the firmware stored in the storage means (21-1) or firmware module thereof to the energy meter (23) along with the update time information. Referring to FIG. 2b, the control means (21-3) transmits the update execution instruction to the energy meter (23) when a current time becomes a relevant update time, after transmitting the firm and the firmware module to the energy meter (23).

Referring to FIG. 2c, the control means (21-3) transmits the firmware stored in the storage means (21-1) or firmware module thereof to the energy meter (23) along with the update time information, and transmits the update execution instruction to the energy meter (23) even before the current time has not become a relevant update time.

The energy meter (23) may include metering means (23-1), communication means (23-2), time check means (23-3), storage means (23-4), a ROM (Read-Only Memory, 23-5), a RAM (Random Access Memory, 23-6) and a processor (23-9).

The metering means (23-1) is connected to the energy supply line (13) to measure energy consumption consumed by a relevant energy consumer as a basic function of the energy meter (23).

The energy consumption measured by the metering means (23-1) may be managed by being stored in the storage means (23-4), and may be visually displayed by a display device that displays the energy consumption, although not illustrated separately.

The communication means (23-2) may communicate with the remote server (21) through the communication network (22). In a non-limiting example, the communication means (23-2) may be a modem connectable to a wired Internet network or a wireless Internet network.

The time check means (23-3) measures a current time. Methods of measuring the current time may be variably formed. In a non-limiting example, the time check means (23-3) may use RTC (Real Time Clock) to measure the current time.

The current time measured by the time check means (23-3) may generate an error, such that the time check means (23-3) may be formed to adjust the current time. The adjustment of the current time may be implemented through communication with other devices, or a user may personally adjust the current time. In the latter case, the energy meter (23) may include a user interface that displays the current time measured by the time check means (23-3) and adjusts the current time.

The storage means (23-4) is a non-volatile storage medium capable of reading and writing for storing and maintaining various pieces of information necessary for operation of the energy meter (23), and particularly stores the firmware update information received from the remote server (21).

The ROM (23-5) stores the firmware which is a program instruction for operation of the energy meter (23), and temporarily stores data immediately accessible by the processor (23-9). Contents stored in the ROM (23-5) may be variably configured based on types of energy and functions required by the energy meter, and can be written as the contents can be immediately updated.

The processor (23-9) may be configured by using a microprocessor or a CPU (Central Processing Unit), and implements an overall control of the energy meter (23) by being operated in response to the program instruction stored in the ROM (23-5).

With reference to the firmware update, the processor (23-9) receives the firmware update information from the remote server (21) through the communication means (23-2) and stores the information in the storage means (23-4) to execute an update at a particular future time.

Referring to FIG. 2a, the processor (23-9) stores the firmware or the firmware module thereof received from the remote server (21) and the firmware update information in the storage means (23-4). The processor (23-9) uses the current time information measured by the time check means (23-3) to monitor whether the update time has come up, and executes the update using the firmware of the firmware module thereof stored in the storage means (23-4), if the update time has come up.

Referring to FIG. 2b, the processor (23-9) stores the firmware or the firmware module thereof received from the remote server (21) in the storage means (23-4), and executes the update using the firmware or the firmware module stored in the storage means (23-4) if an update execution instruction is received from the remote server (21).

Referring to FIG. 2c, the processor (23-9) stores the firmware or the firmware module thereof received from the remote server (21) and the firmware update information in the storage means (23-4). The processor (23-9) uses the current time information measured by the time check means (23-3) to monitor whether the update time has come up, and executes the update using the firmware of the firmware module thereof stored in the storage means (23-4), if the update time has come up.

Furthermore, the processor (23-9) executes the update using the firmware or the firmware module thereof stored in the storage means (23-4) if an update execution instruction is received from the remote server (21) even before the update time has come up. In this case, the same firmware of firmware module is not updated even if the update time has come up thereafter.

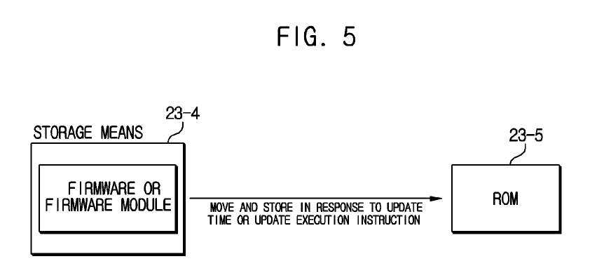

At this time, the term of executing, implementing or performing the firmware update means that the energy meter (23) is so processed as to be operated in response to a new firmware. In a non-limiting example, as shown in FIG. 5, a new firmware or a new firmware module stored in the storage means (23-4) is recorded in the ROM (23-5). If the program instruction recorded in the ROM (23-5) is updated, the energy meter (23) operates in response to contents in the new firmware or firmware module.

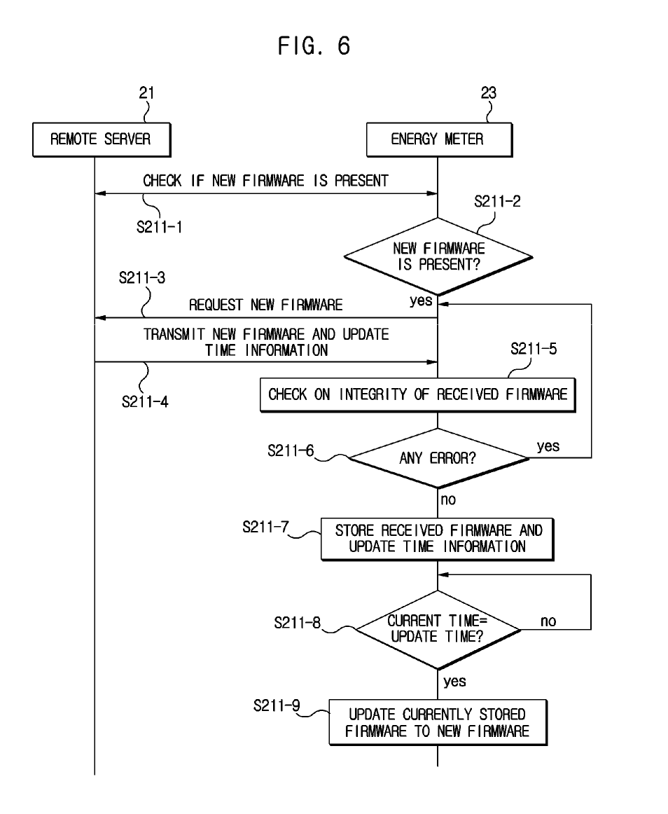

A remote firmware update method according to the present disclosure will be described with reference to FIGS. 6 to 9.

FIG. 6 illustrates an exemplary embodiment in which the remote server transmits the firmware and the update time information as firmware update information.

First, the remote server (21) transmits a new firmware and update time information to the energy meter (23) through a communication network. There may be various configurations as to when the remote server (21) transmits the firmware.

In a non-limiting example, the energy meter (23) is periodically connected to the remote server (21) to check if a new versioned firmware is present (S211-1), and if there is a new firmware that has not been downloaded as a result of the check (S211-2), configuration may be so formed as to request the remote server (21) of the download (S211-3). Then, the remote server (21) transmits a relevant firmware to the energy meter (23) in response to the request (S211-4).

The energy meter (23) checks the integrity of the firmware received through the step S211-4, and as a result of the check (S211-5), if the firmware has not been normally received, the energy meter (23) requests the remote server (21) of the relevant firmware and receives the firmware again.

However, as a result of the check, if the firmware has been normally received (S211-6), the energy meter (23) stores the received firmware and update time information in the storage means (S211-7).

Now, the energy meter (23) monitors whether the current time has become the update time stored in the storage means (S211-8). As a result of the monitoring at step S211-8, if it is determined that the current time has become the update time stored in the storage means, the energy meter (23) execute the update using the new firmware stored in the storage means (S211-9).

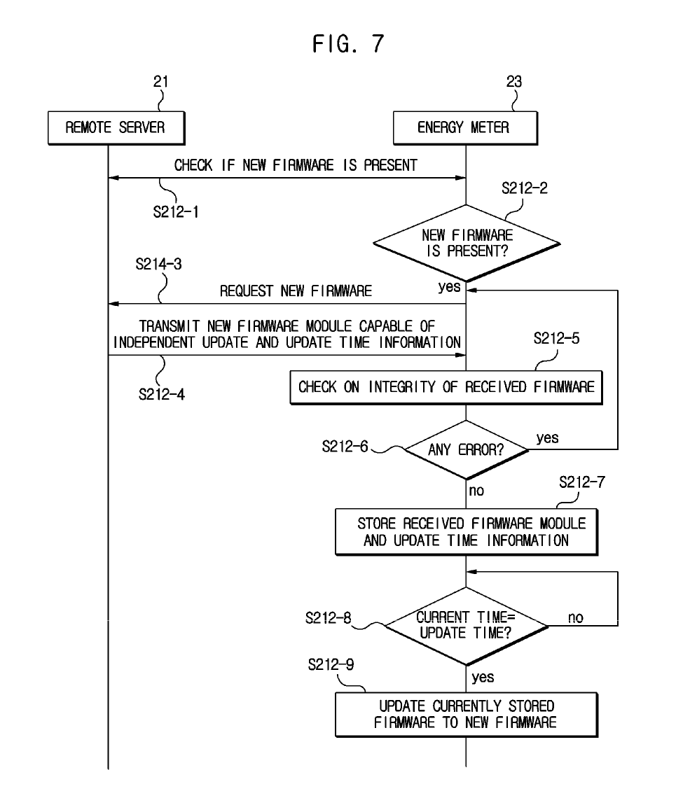

FIG. 7 is an exemplary embodiment in which the remote server transmits firmware of module unit and update time information thereof as firmware update information.

First, the remote server (21) transmits a firmware module capable of executing an independent update and update time information thereof to the energy meter (23). There may be various configurations as to when the remote server (23) transmits the firmware.

In a non-limiting example, the energy meter (23) is periodically connected to the remote server (21) to check if a new versioned firmware is present (S212-1), and if there is a new versioned firmware module that has not been downloaded as a result of the check (S212-2), configuration may be so formed as to request the remote server (21) of the download (S212-3). Then, the remote server (21) transmits a relevant firmware module to the energy meter (23) in response to the request (S212-4).

The energy meter (23) checks the integrity of the firmware module received through the step S212-4 (S212-5), and as a result of the check, if the firmware module has not been normally received, the energy meter (23) requests the remote server (21) of the relevant firmware module and receives the firmware module again.

However, as a result of the check, if the firmware module has been normally received (S212-6), the energy meter (23) stores the received firmware module and update time information in the storage means (S212-7).

Now, the energy meter (23) monitors whether the current time has become the update time stored in the storage means (S212-8). As a result of the monitoring at step S212-8, if it is determined that the current time has become the update time stored in the storage means, the energy meter (23) execute the update using the new firmware module stored in the storage means (S212-9).

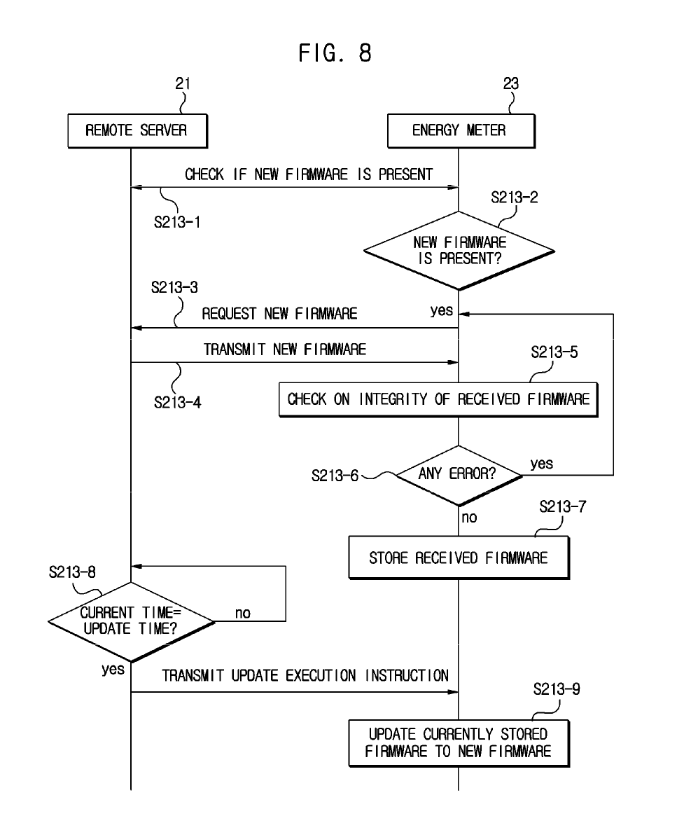

FIG. 8 is an exemplary embodiment in which the remote server transmits firmware in advance as firmware update information, and then transmits an update execution instruction to a relevant firmware.

First, the remote server (21) transmits a new firmware to the energy meter (23) through a communication network. There may be various configurations as to when the remote server (21) transmits the firmware.

In a non-limiting example, the energy meter (23) is periodically connected to the remote server (21) to check if a new versioned firmware is present (S213-1), and if there is a new versioned firmware that has not been downloaded as a result of the check (S213-2), configuration may be so formed as to request the remote server (21) of the download (S213-3). Then, the remote server (21) transmits a relevant firmware to the energy meter (23) in response to the request (S213-4).

The energy meter (23) checks the integrity of the firmware received through the step S213-4 (S213-5), and as a result of the check, if the firmware has not been normally received, the energy meter (23) requests the remote server (21) of the relevant firmware and receives the firmware again.

However, as a result of the check, if the firmware has been normally received (S213-6), the energy meter (23) stores the received firmware and update time information in the storage means (S213-7).

Meantime, if the current time has become the firmware update time transmitted through the step S213-4 (S213-8), the remote server (21) transmits an update execution instruction to the energy meter (23) (S213-9). If the update execution instruction is received from the remote server (21) through step S213-9, the energy meter (23) executes the update using the new firmware stored in the storage means (S213-10).

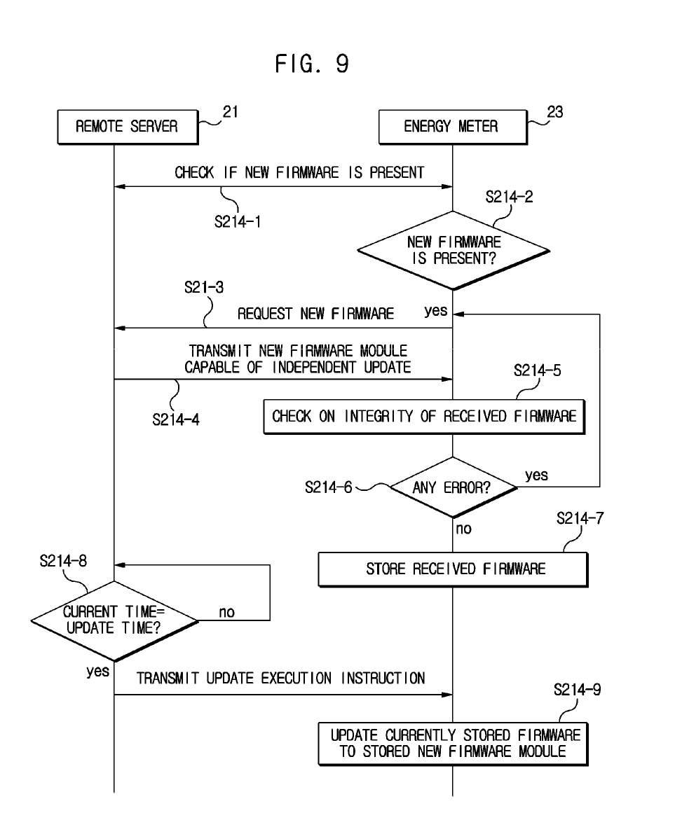

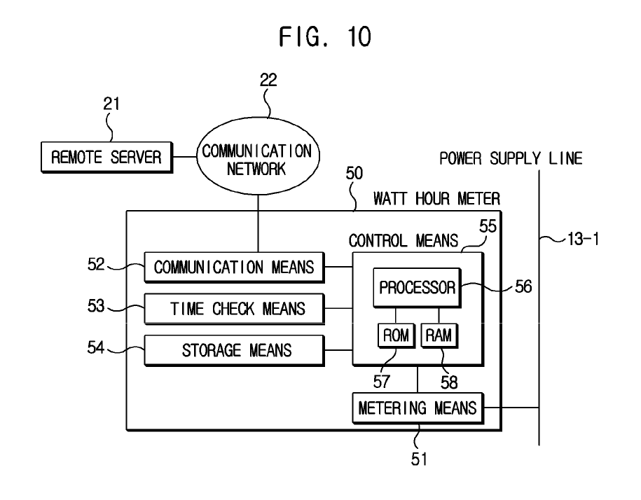

FIG. 9 is an exemplary embodiment in which the remote server transmits a firmware module in advance as firmware update information, and then transmits an update execution instruction to a relevant firmware module.

First, the remote server (21) transmits a firmware module capable of executing an independent update to the energy meter (23) through the communication network. There may be various configurations as to when the remote server (23) transmits the firmware.

In a non-limiting example, the energy meter (23) is periodically connected to the remote server (21) to check if a new versioned firmware is present (S214-1), and if there is a new versioned firmware that has not been downloaded as a result of the check (S214-2), configuration may be so formed as to request the remote server (21) of the download (S214-3). Then, the remote server (21) transmits a relevant firmware module to the energy meter (23) in response to the request (S214-4).

The energy meter (23) checks S214-5 the integrity of the firmware module received through the step S214-4, and as a result of the check, if the firmware module has not been normally received, the energy meter (23) requests the remote server (21) of the relevant firmware module and receives the firmware module again.

However, as a result of the check, if the firmware module has been normally received (S214-6), the energy meter (23) stores the received firmware module in the storage means (S214-7).

Meantime, if the current time has become the firmware update time transmitted through the step S214-4 (S214-8), the remote server (21) transmits an update execution instruction to the energy meter (23) (S214-9). If the update execution instruction is received from the remote server (21) through step S214-9, the energy meter (23) executes the update using the new firmware module stored in the storage means (S214-10).

The exemplary embodiments in FIGS. 6 to 9 have described methods of downloading a new firmware in which the energy meter (23) is periodically connected to the remote server (21) to check if a new versioned firmware is present.

However, there may be various configurations as to when the remote server (23) transmits the firmware, such that the methods are not limited thereto.

To be more specific, if there is a new firmware, the remote server (21) informs the presence of the new firmware to the energy meter (23), whereby the firmware download at the energy meter (23) can be executed.

In the remote firmware update system and methods of various exemplary embodiments thus described, the energy meter (23) may record and store currently operating firmware information, a firmware update attempt, and a history of a result of the firmware update attempt. The firmware information to be stored may include version information and update time.

Furthermore, even if the firmware or the firmware module is updated, the energy meter (23) can maintain, without any change, operation environment (configuration) information preset before the update, e.g., environment information set up by a user or communication environment information with the remote server that needs to be maintained as is.

Referring to FIG. 10, an exemplary embodiment of a watt hour meter (50) capable of remote firmware update will be described according to the present disclosure.

The watt hour meter (50) may include measuring means (51), communication means (52), time check means (53), storage means (54) and control means (55).

The measuring means (51) is connected to a power supply line (13-1) to measure energy consumption consumed by a relevant energy consumer as a basic function of the energy meter (23).

The energy consumption measured by the metering means (51) may be managed by being stored in the storage means (54), and may be visually displayed by a display device that displays the energy consumption, although not illustrated separately.

The communication means (52) may communicate with the remote server (21) through the communication network (22). In a non-limiting example, the communication means (52) may be a modem connectable to a wired Internet network or a wireless Internet network.

The time check means (53) measures a current time. Methods of measuring the current time may be variably formed. In a non-limiting example, the time check means (53) may use RTC (Real Time Clock) to measure the current time.

The current time measured by the time check means (53) may generate an error, such that the time check means (53) may be formed to adjust the current time. The adjustment of the current time may be implemented through communication with other devices, or a user may personally adjust the current time. In the latter case, the watt hour meter (50) may include a user interface that displays the current time measured by the time check means (53) and adjusts the current time.

The storage means (54) is a non-volatile storage medium capable of reading and writing for storing and maintaining various pieces of information necessary for operation of the watt hour meter (50), and particularly stores the firmware update information received from the remote server (21).

The control means (55) may include a ROM (57), a RAM (58) and a processor (56).

The ROM (57) stores the firmware which is a program instruction for operation of the watt hour meter (50), and temporarily stores data immediately accessible by the processor (56). Contents stored in the ROM (57) may be variably configured based on types of energy and functions required by the energy meter, and can be written as the contents can be immediately updated.

The processor (56) may be configured by using a microprocessor or a CPU (Central Processing Unit), and implements an overall control of the watt hour meter (50) by being operated in response to the program instruction stored in the ROM (57).

With reference to the firmware update, the processor (56) receives the firmware update information from the remote server (21) through the communication means (52) and stores the information in the storage means (54) to execute an update at a particular future time.

With reference to reception of firmware update information, the processor (56) may be periodically connected to the remote server (21) through the communication means (52) to check if there is a new updated versioned firmware or firmware module thereof, and request the remote server (21) of download if there is any new firmware or firmware module thereof that has not been downloaded.

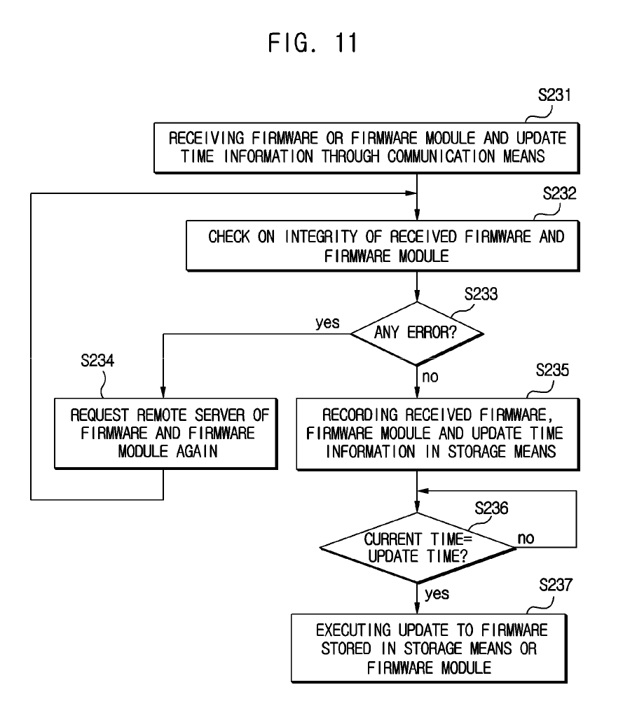

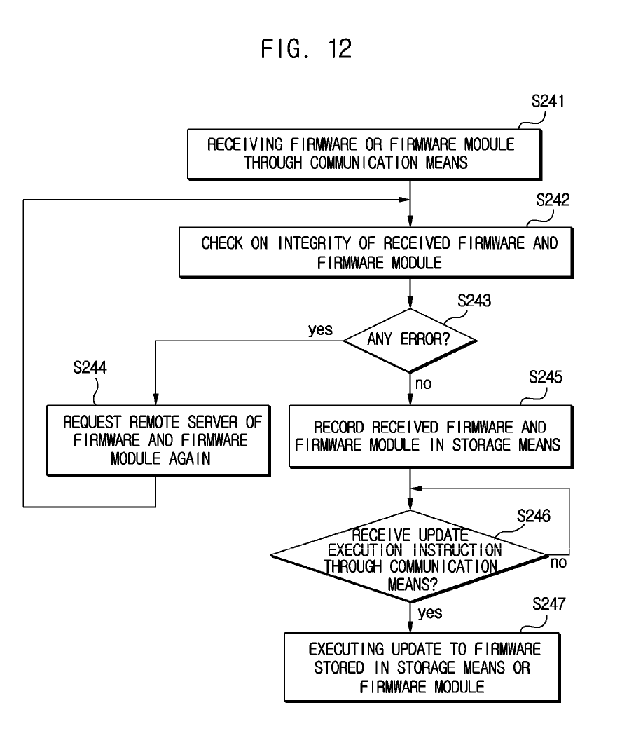

FIGS. 11, 12 and 13 are flowcharts describing detailed processes in which a watt hour meter operates according to various exemplary embodiments of the present disclosure.

The watt hour meter (50) according to the present disclosure may be variably configured based on firmware update information transmitted by the remote server (21) and when an actual firmware update will be executed.

Referring to FIG. 11, a first exemplary embodiment will be described in which firmware, a firmware module thereof and update time information are received from the remote server (21).

The processor (56) receives firmware, a firmware module thereof and update time information from the remote server (21) through the communication means (52) (S231), and checks integrity of the received firmware and firmware module (S232). As a result of the check on the integrity, if there is an error (S233), the processor (56) requests the remote server (21) of a relevant firmware or a firmware module thereof and receives same again (S234).

However, if there is no error as a result of check on integrity (S233), the processor (56) records the received firmware or module thereof and update time information in the storage means (54) (S235).

Now, the processor (56) uses the current time information measured by the time check means (53) to monitor whether the current time has become the update time recorded in the storage means (54) (S236), and as a result of the monitoring at step S236, if it is determined that the current time has become the update time recorded in the storage means (54), the processor (56) executes the update to the firmware or firmware module stored in the storage means (54) (S237).

That is, the processor moves the relevant firmware or module thereof stored in the storage means (54) to the ROM (57), whereby the firmware or the firmware module are operated based on the new firmware or firm module.

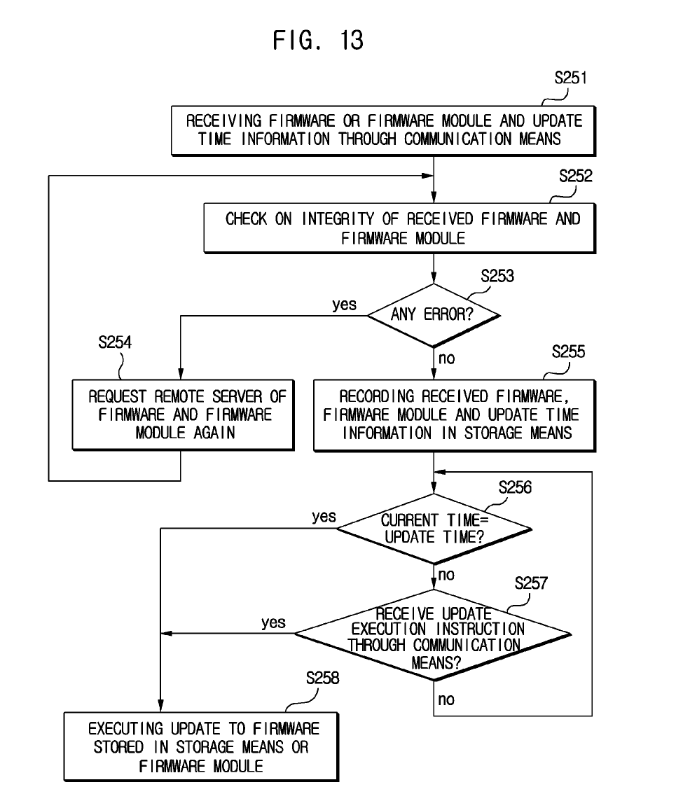

Referring to FIG. 12, a second exemplary embodiment will be described in which firmware and firmware module thereof are first received from the remote server (21), and then an update execution instruction is received from the remote server (21).

The processor (56) receives firmware and firmware module from the remote server (21) through the communication means (52) (S241), and checks integrity of the received firmware and firmware module (S242). As a result of the check on the integrity, if there is an error (S243), the processor (56) requests the remote server (21) of a relevant firmware or a firmware module thereof and receives same again (S244).

However, if there is no error as a result of check on integrity (S243), the processor (56) records the received firmware or module thereof and update time information in the storage means (54) (S245).

Now, the processor (56) is in a state of waiting for update execution instruction from the remote server (21), and the processor (56) executes the firmware or module update (S247) if received of the update execution instruction from the remote server (21) (S246). That is, the processor moves the relevant firmware or module thereof stored in the storage means (54) to the ROM (57), whereby the firmware or the firmware module are operated based on the new firmware or firm module.

Referring to FIG. 13, an exemplary embodiment will be described in which update is selectively executed in response to update time information or update execution instruction.

First, the processor (56) receives firmware, a firmware module thereof and update time information from the remote server (21) through the communication means (52) (S251), and checks integrity of the received firmware and firmware module (S252). As a result of the check on the integrity, if there is an error (S253), the processor (56) requests the remote server (21) of a relevant firmware or a firmware module thereof and receives same again (S254).

However, if there is no error as a result of check on integrity (S253), the processor (56) records the received firmware or module thereof and update time information in the storage means (54) (S255).

Meantime, the processor (56) uses the current time information measured by the time check means (53) to monitor whether the current time has become the update time recorded in the storage means (54) (S256), and to monitor whether update execution instruction has been received from the remote server (21) through the communication means (52) (S257).

As a result of the monitoring at step S256, if it is determined that the current time has become the update time recorded in the storage means (54) or the update execution instruction has been received from the remote server (21), the processor (56) executes the update to the firmware or firmware module stored in the storage means (54)(S257).

That is, the processor (56) moves the relevant firmware or module thereof stored in the storage means (54) to the ROM (57), whereby the firmware or the firmware module are operated based on the new firmware or firm module.

In a case the update is executed before the current time becomes the update time in response to the update execution instruction from the remote server (21), update to the same firmware or firmware module is not executed again even if the current time becomes the update time.

In the exemplary embodiment where the watt hour meter (50) updates firmware for each module, the firmware may include a module in charge of application of the energy meter, a module in charge of communication, and a module in charge of metrology.

In the watt hour meter of each exemplary embodiment thus described, the processor (56) may record and store currently operating firmware information, a firmware update attempt, and a history of a result of the firmware update attempt. The firmware information to be stored may include version information and update time.

Furthermore, even if the firmware or the firmware module is updated, the energy meter (23) can maintain, without any change, operation environment (configuration) information preset before the update, e.g., environment information set up by a user or communication environment information with the remote server that needs to be maintained as is.

The system and method for firmware update of meter, watt hour meter with function of remote firmware update according to the present disclosure may, however, be embodied in many different forms and should not be construed as limited to the embodiments set forth herein. Thus, it is intended that embodiments of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

The present disclosure is advantageous in that each energy meter can execute its own firmware update by itself when the update time has come up or receives an update execution instruction is received from remote server by downloading and storing in advance the firmware from the remote server. That is, the firmware or firmware module is downloaded in advance to each energy meter before a firmware update time comes up.

The present disclosure is further advantageous in that there is no need for each energy meter to download firmware at once to dispersively execute the download information for firmware update, whereby load of remote server or communication network for firmware upgrade can be dispersed and firmware update processing can be smoothly executed.

Each energy meter can execute its own firmware update by it self at a relevant time in response to update time information downloaded along with the firmware or update execution instruction transmitted from the remote server, such that a plurality of energy meters can be updated at one time at a particular time, compatibility among the plurality of energy meters can be equally maintained to provide convenience in management thereof.

What is claimed is:

1. A system for remote firmware update of an energy meter, the system comprising: a remote server generating and managing operation of firmware (program instruction) of an energy meter; a communication network connecting the remote server and the energy meter; and an energy meter receiving a new firmware module from the remote server through the communication network capable of update for each module and update time information which is a future time on which the new firmware module operates, and recording the new firmware module and the update time information in storage means, wherein the remote server transmits the new firmware module and the update time information to the energy meter prior to the update, and the energy meter checks integrity of the received new firmware module, and independently executes the update operation at the update time for each module recorded in the storage means.

2. The system of claim 1, wherein the firmware includes at least one or more of a module in charge of application of the energy meter, a module in charge of communication and a module in charge of metrology.

3. The system of claim 1, wherein the energy meter stores currently operating firmware information including at least a firmware version and a firmware update time in the storage means.

4. The system of claim 1, wherein the energy meter records a firmware update attempt and a history of a result of the firmware update attempt in the storage means.

5. The system of claim 1, wherein the energy meter operates in response to operation environment (configuration) set up prior to firmware update, even if the firmware update has been executed.

6. A method for remote firmware update of an energy meter, the method comprising: transmitting a new firmware and update time information in advance, by a remote server generating firmware and managing operation of the firmware of an energy meter, to the energy meter; receiving, by the energy meter, the new firmware and the update time information from the remote server and storing the new firmware and the update time information in storage means; monitoring, by the energy meter, whether a current time has become an update time; and updating, by the energy meter, a current firmware to a new firmware recorded in the storage means, if the current time has become the update time as a result of the monitoring.

7. The method of claim 6, wherein the firmware includes at least one or more of a module in charge of application of the energy meter, a module in charge of communication and a module in charge of metrology.

8. The method of claim 6, wherein the energy meter stores currently operating firmware information including at least a firmware version and a firmware update time, in the storage means.

9. The method of claim 6, wherein the energy meter records a firmware update attempt and a history of a result of the firmware update attempt in the storage means.

10. The method of claim 6, wherein the energy meter operates in response to configuration set up prior to firmware update, even if the firmware update has been executed.

11. A watt hour meter with function of remote firmware update, the watt hour meter comprising: communication means receiving, from a remote server through a communication network, a new firmware of the watt hour meter and update time information which is a future time on which the new firmware operates; non-volatile storage means recording the received new firmware and update time information; time check means measuring a current time, wherein the watt hour meter checks integrity of the new firmware, and operates with the new firmware if the current time measured by the time check means becomes the update time recorded in the storage means.

12. The watt hour meter of claim 11, wherein the firmware includes at least one or more of a module in charge of application of an energy meter, a module in charge of communication and a module in charge of metrology.

13. The watt hour meter of claim 11, wherein the current time measured by the time check means is adjustable.

14. The watt hour meter of claim 11, wherein the adjustment of the current time is executed by communication with other devices, or executed by a user's personal set-up through user interface mounted at the watt hour meter.

15. The watt hour meter of claim 11, wherein the watt hour meter stores currently operating firmware information including at least a firmware version and a firmware update time, in the storage means.

16. The watt hour meter of claim 11, wherein the watt hour meter records a firmware update attempt and a history of a result of the firmware update attempt in the storage means.

17. The watt hour meter of claim 11, wherein the watt hour meter operates in response to configuration set up prior to firmware update, even if the firmware update has been implemented.
